(19) United States
(12) Patent Application Publication
(10) Pub. No.: US 2003/0181197 A1
(43) Pub. Date: Sep. 25, 2003

(54) System providing control of a function via telephone network

(76) Inventor: Jarl Larsson, Osterskar (SE)

Correspondence Address: NIXON & VANDERHYE, PC, 1100 N GLEBE ROAD, 8TH FLOOR, ARLINGTON, VA, 22201-4714, US

(21) Appl. No.: 10/381,425

(22) PCT Filed: Sep. 24, 2001
(86) PCT No.: PCT/SE01/02043

(30) Foreign Application Priority Data
Sep. 25, 2000 (SE) 0003422-3

(51) Int. Cl. H04M 3/16; H04M 1/68; H04M 1/66

(52) U.S. Cl. 455/414.1; 455/411

(57) ABSTRACT

The invention relates to a function control system (1) in which a function practitioner (4) included among a plurality of available function practitioners is able to report his/her position and/or customer-related function to a common unit (3) via a telephone network (2) for control purposes, wherein said unit is adapted to handle communication from a mobile telephone apparatus (4a) belonging to respective function practitioners. In connection with a customer (10), the function practitioner (4) shall activate, via his/her mobile telephone apparatus (4a), a call, via the telephone network (2), to said common unit (3), which is adapted to receive and register control signals sent 4a from the telephone network, said signals having the form of ringing signals originating from the call from said function practitioner (4), and to register selected criteria relating to the call concerned, such as A-number identification, B-number identification, and/or the time at which the call was received. The common unit (3) thus registers at least the function practitioner (4) and the customer (10) connected via a signal exchange relating to said control signals associated with the call and generated in the telephone network.

### FIELD OF THE INVENTION

The present invention relates generally to a system that provides a function control, and more particularly to such a system in which each of a plurality of accessible function practitioners and/or service practitioners are able to report their respective geographical positions and/or customer-related function to a common unit via a telephone network in respect of a desired reporting and/or controlling procedure, wherein said system is adapted to handle communication from and to to mobile telephone apparatus or cellphones belonging to respective function practitioners.

The invention thus relates to a system, which can provide a function control and/or an activity follow-up.

Although the present invention can be applied quite generally as a result of its structure, it will be understood that the invention has been developed with the intention of providing a function control and/or activity follow-up in respect of home carers, and to provide simple reporting and/or controlling of the duties, functions and services carried out by the carers, and to keep an account of customers associated with respective home carers or service practitioners and, in addition, to provide an emergency service both with respect to home carers and respective care receivers

### DESCRIPTION OF THE BACKGROUND ART

Several different types and applications of such systems are known to the art.

For example, various function control systems are known to the art, and then particularly systems which are based on reporting and therewith checking that watchers, guards, home carers and other persons that perform similar duties actually carry out the duties assigned to them, and where there exists a strong need to establish continuously, or at least generally continuously, the geographical position of a home carer and the current time at which the duties of respective carers or like persons are carried out.

Such a system is based on the principle of allowing each home carer to make a call and to establish speech contact via a customer telephone or a home carer telephone, via a speech channel established with a central unit which is common to several home carers and which is manned by one or more supervisors or work managers.

In this case, reporting is carried out orally via an established speech connection, where the caller is responsible for the cost incurred in respect of a telephone operator associated with the call and the speech channel used.

The information divulged as to the whereabouts of the home carer will constitute relevant information with respect to the geographical position of the trained home helper and can also provide information as to the time at which the speech connection was actually established, wherewith both of these pieces of information can be safely noted.

Another function controlling system is based on requiring a guard or security person to record his/her presence in a number of sequential and predetermined geographical positions during his/her security round, by activating acknowledgement of his/her presence in each neighbourhood and at each place.

Because the inventive system requires access to a telephone network that includes telephone exchanges or switching centres, it can be mentioned that the required telephone network and its telephone exchanges must be designed to provide identification of at least the A-numbers concerned, i.e. the subscriber number of the calling person.

The telephone network and the telephone exchanges or switching centres may also be designed to provide clear identification of the B-numbers concerned, i.e. the subscriber number of the called person.

In order to clarify the significant features of the present invention, it may be mentioned that telephone networks and associated telephone exchanges of the kind intended here may be divided simply into at least two function parts or blocks, i.e. a first function block that affords different signal exchanges via control signals, and a second function block which provides a through-connection of a speech channel or speech connection immediately the called person responds to a ringing signal or corresponding signal delivered by the telephone network through a telephone exchange.

In simple terms, the first function block can be assumed to send a coupling tone to the calling telephone, to note the subscriber number, or the like, of the called telephone to check that the telephone network has a vacant speech channel that can be coupled between the calling and called subscribers associated with the system, and to activate a ringing signal to the called subscriber together with an A-number identification.

In the following text, this is designated “control signal activity” or control signal related signal exchange.

The second function block is activated immediately the called subscriber answers the call and establishes a vacant speech channel between the calling and the called subscribers for the exchange of information over the speech channel thus established.

The contents of the following patent publications also form part of the earlier standpoint of techniques.

U.S. Pat. No. 5,646,839

This publication illustrates and describes a computer-based system that includes hardware, which serves as an interface to the public telecommunications system and for accepting incoming calls related to the telephone network.

In this case, the computer system determines the number information related data (AIN data) from each incoming telephone call, such as data that identifies the calling subscriber, and is also able to accept a person identification data code from the calling subscriber via an established connection.

This system is designed to be able to create a report by co-ordinating the current position of the calling apparatus and the person initiating the telephone call.

More particularly, the system is designed to be able to determine remotely and via the public telecommunications network the time of arrival of an employee and worker at different workplaces and the time at which said employee leaves his/her place of work.

Thus, this patent publication describes the aforementioned proposal of utilising so-called A-number identification, and also a system which utilises A-number identification in order to collect data that can be used to carry out economic transactions, wherein the system includes a drawback wherein it must be absolutely certain that the person making the call is actually the person registered to the telephone apparatus.

The application taught by patent publication U.S. Pat. No. 5,646,839 does not require the same high degree of security as that required by the present invention and the objects of the invention with respect to the described system reside, in principle, in keeping a record of arrival and departure times in respect of field workers.

In this prior patent publication, identification of the calling subscriber is effected over a coupled connection and by the use of speech channels.

### SUMMARY OF THE PRESENT INVENTION

Technical problems

When taking into consideration the technical deliberations that a person skilled in this particular art must make in order to provide a solution to one or more technical problems that he/she encounters, it will be seen that on the one hand it is necessary initially to realise the measures and/or the sequence of measures that must be undertaken to this end, and on the other hand to realise which means is/are required to solve one or more of said problems. On this basis, it will be evident that the technical problems listed below are very relevant to the development of the present invention.

When considering the earlier state of the art, as described above, it will be seen that a technical problem resides in being able to realise the significance of and the advantages associated with creating conditions, with the aid of very simple means and measures, which will enable one or each system-associated function practitioner when making a report and a control to indicate and disclose his/her geographic position and also the geographic position of a selected customer/client, and also the time at which the function was carried out, by providing the function practitioner with access to a mobile telephone apparatus by means of which he/she may make a call to a central unit that divulges customer-related identification.

Another technical problem resides in the ability to realise the significance of and the advantages afforded by allowing said function practitioner to initiate via his/her mobile telephone apparatus in relation to a customer a call to a central or common unit that is accessible to a plurality of function practitioners via the telephone network, without requiring said call and the information delivered to entail internal and/or external costs.

Another technical problem is one of being able to realise the significance of and the advantages afforded by adapting said common unit to receive and record/register “control signals” generated within said telephone network and transmitted therefrom and originating from the call made by said chosen function practitioner.

Another technical problem resides in the ability to realise the significance of and the advantages afforded by adapting the common unit in the aforedescribed system to register a chosen number of criteria relating to a call, such as at least the time at which the call was made, the function practitioner responsible for the call, the customer concerned and also the duty to be performed by the employee.

Another technical problem is one of being able to realise the significance of and the advantages afforded by adapting said common unit to register at least the function practitioner and the customer concerned via “control signals” associated with a given call created within the telephone network, said “control signals” including signal exchange.

Still another technical problem is one of realising the significance of and the advantages afforded by connecting a common unit adapted for a chosen number of function practitioners or home carers to be coupled to one or more subordinate units.

Because each function practitioner has access to a mobile telephone operator, a technical problem resides in the ability of realising the significance of and the advantages afforded by allowing the customers/clients of the function practitioner in the case of a system of the aforedescribed kind and having fictive unit-allocated telephone numbers to be co-ordinated in a SIM card belonging to the mobile telephone apparatus.

Another technical problem is one of being able to realise the significance of and the advantages afforded by allowing the function practitioner to activate a call to the common unit based on a significant telephone number adapted for access to a time recording system.

Yet another technical problem resides in the ability to realise the significance of and the advantages afforded by allowing one or each item of information received by the common unit to be transferred to a subordinate unit and stored therein.

In respect of a system of the kind described in the introduction, a technical a problem also resides in the ability to realise the significance of and the advantages associated by allowing a call to be activated to the common unit via said telephone network by selecting a customer's name on the display of said mobile telephone apparatus and initiating the call desired via the functions associated with said telephone apparatus in a known manner.

Another technical problem is one of being able to realise the significance of and the advantages afforded by adapting the common unit for transmission of received information to a subordinate unit, said information possibly relating to the function practitioner and the customer concerned, and registering this information and a current time point in said subordinate unit.

Yet another technical problem is one of being able to realise the significance of and the advantages associated with allowing the function practitioner, through the medium of a call, to send to the common unit and/or to a chosen subordinate unit the nature of each chosen function and/or service. This may concern, in particular, allowing the call to have the form of a card number belonging to the telephone apparatus in question.

Another technical problem is one of being able to realise the significance of and the advantages associated with allowing a function practitioner, upon termination of a function and/or termination of a service on the part of the function practitioner, to send to the unit, through the medium of a call, a telephone-related status number relating to a commenced and/or terminated function or service.

Another technical problem is one of realising the significance of and the advantages that are afforded by allowing the function practitioner to activate a call to the common unit or equipment on the basis of a telephone number adapted for entry into or departure from a time recording system.

It will also be seen that a technical problem also resides in the ability to realise the significance of enabling the function practitioner to activate a call number to a manned work management centre, preferably initiated by a stored card number, in the case of an emergency.

Still another technical problem is one of being able to realise the significance of and the advantages that are afforded by enabling the geographical position of the function practitioner to be determined on the basis of the information delivered to said common unit, said information being transmitted to the work management centre.

In the event of the lack of response to a call made to the work management centre within a predetermined time interval, a problem resides in realising the necessity of switching such a call to equipment functioning as an emergency service.

Still another technical problem is one of realising the significance of and the advantages associated with allowing a person in need of help in an emergency to activate a call to said unit and call, via said unit, said manned work management centre, in which the geographic position is stored in a co-ordinate system for each customer, wherewith the nearest and/or the best available function practitioner can be called on the basis of the stored co-ordinates concerning each function practitioner.

In addition, a technical problem resides in the provision of conditions, with the aid of simple means and measures, that will enable a care receiver to register as a customer in a customer register with the aid of a fictive telephone number and/or with the aid of one and the same fictive telephone number belonging to several customers although with a telephone number allocated to the telephone apparatus of the home carer such as to clearly point-out one, and only one, customer.

Another technical problem resides in the ability to realise the significance of and the advantages associated with enabling a SIM card to be updated with the aid of a computer-based card support where the address of the care receiver is registered together with a fictive telephone number allocated to his/her name, among other things.

Yet another technical problem resides in the ability to realise the significance of and the advantages associated with registering the arrival of a practitioner at a chosen customer or care receiver, by calling the fictive telephone number of the care receiver, for instance via the internal register of the mobile telephone apparatus.

Another technical problem is one of being able to realise the significance of and the advantages associated by arranging for a telephone number allocated to several function practitioners to represent the commencement of the type of function or event concerned, and by arranging for another telephone number to represent the termination of said type of determined function or event, and to note the time at which said calls were made to said telephone number.

Another technical problem is one of being able to realise the significance of and the advantages associated with allowing the telephone number of the customer or the care receiver to be registered in the system, and by allowing initiation of a call to take place to a particular number.

In order to be able to reduce the number of fictive telephone numbers to the central unit, it is necessary to realise the significance of and the advantages associated with allocating to a customer for each home carer one and the same fictive telephone number, and to provide the central unit with means that combines A-number identification and B-number identification so as to select to one, and only one, customer, namely the customer allocated the calling home carer having the B-number identification in question.

Solution

With the intention of providing a solution to one or more of these technical problems, the present invention takes as its starting point a function control system in which one of a number of available function practitioners is able to report, via a telephone network, either directly or indirectly, his/her geographical position and/or customer related function to a common unit allocated to a group of function practitioners, wherein said common unit is adapted to handle at least communication from the telephone network and telephone exchanges or switching centres included in said network with respect to calls initiated from mobile telephone apparatus or cellphones in the possession of respective function practitioners.

The present invention also relates to the execution of a number of sequentially related procedures,

wherein in respect of a customer, the function practitioner shall initiate and activate via his/her mobile telephone apparatus a customer related call to a common unit via a telephone network and a telephone exchange included in said network;

wherein the common unit shall function to receive and to register “control signals” sent from the telephone network and the telephone exchange, said signals originating from the call according to “a” above from the function practitioner;

wherein said common unit shall function to register a chosen number of criteria concerning the call in question, such as the time at which the call was made, the function practitioner concerned and the customer concerned; and

wherein said common unit shall function to register at least the function practitioner and the customer concerned through the medium of a signal exchange relating to said “control signals” generated within the telephone network and associated with said call.

By way of suggested embodiments that lie within the scope of the inventive concept, it is proposed that the common unit can be coupled to one or more subordinate units.

It is also proposed that all customers of a function practitioner can be coordinated in a SIM card belonging to said mobile telephone apparatus.

It is also proposed that the function practitioner shall be able to activate a call to the common unit on the basis of a significant telephone number adapted for entry to a time recording system.

It is also proposed that information received from the telephone network by the common unit can be transferred to one or more subordinate units connected to said common unit, either directly or subsequent to being processed, for storage and co-ordination of information in each of said subordinate units.

It is also proposed that the function practitioner shall be able to choose a customer's name on the display of the mobile telephone apparatus and to initiate a call to said common unit in a known manner.

It is also proposed that the common unit shall be adapted for the transmission of information to a subordinate unit at least with respect to the function practitioner and the customer concerned, so that this information can be coordinated and registered in said subordinate unit together with the time at which the information was received.

In addition, it is also proposed in accordance with the invention that the function practitioner shall send to the common unit and/or to a chosen subordinate unit, by call activation, an indication and information relating to the commencement, and preferably also the termination, of each chosen function and/or service, particularly with the aid of a card number.

It is also proposed that at the commencement of and/or at the termination of a function and/or service of predetermined duration, the function practitioner shall be able to send a status number applicable to a chosen function and/or service via a call to said common unit.

It is also proposed in accordance with the invention that a function practitioner or all function practitioners shall be able to activate a call to the common unit at the end of a working period, said call being based on a significant telephone number adapted to allow the server/servers to exit from a time recording system.

It is particularly proposed that the function practitioner will be able to activate a call number, stored as a card number, to a manned work management centre via the common unit in the event of an emergency.

It is also proposed that the geographical position of the function practitioner can be determined on the basis of information delivered to said common unit, and that said geographical position can be disclosed to a work management or supervisory centre.

It is also proposed in accordance with the invention that in the absence of a reply to a call to the common unit or to the work management centre within a predetermined time interval, a call is made to equipment that functions to provide a rescue service.

It is also proposed in accordance with the invention that when a customer is himself/herself in acute need of assistance, the customer will activate a call to the common unit or, via said unit, to the manned work management centre, in which the co-ordinates of the geographical position of each customer may be stored, wherewith the nearest and/or the best available function practitioner in respect of these co-ordinates stored and applicable to each function practitioner can be summoned for assistance.

It is also proposed that each customer or care receiver is registered in a customer register with the aid of a fictive telephone number that is separate from the system-associated subscriber number of the care receiver or from the subscriber number related to the telephone network.

It is also proposed that updating of a SIM card is effected with the aid of a computer-based card support and/or map support, where the address of the customer or care receiver is registered together with the name and fictive telephone number that has been allocated to the customer or care receiver, among other things.

The arrival of a practitioner at a chosen customer or care receiver shall be registered by calling the common unit via a fictive telephone number allocated to the care receiver, such as a telephone number obtained through the internal register of the mobile telephone apparatus or cellphone.

A telephone number allocated to preferably several function practitioners may be adapted to represent a determined type of function or activity.

The subscriber telephone number of the customer or care receiver is registered in the system and each call is initiated with the aid of a separate unit-allocated telephone number.

One and the same fictive telephone number may be allocated to a customer of each home carer, therewith reducing the number of fictive telephone numbers, where each customer can be clearly identified by determining the subscriber number allocated to the mobile telephone apparatus of the home carer.

Advantages

Those advantages primarily characteristic of an inventive function control system reside in the creation of conditions which allow a function practitioner, such as a security guard, watchman, home help, or home carer, to have access to a mobile telephone apparatus and to be able to initiate via said apparatus a call to a common unit that is associated with a plurality of function practitioners, e.g. home carers, such as to allow information that indicates that certain planned functions and/or services shall be carried out or have been carried out to be sent to the common unit, and that this communication between the mobile telephone apparatus and the common unit is effected over a telephone network, such as a network that includes a number of telephone exchanges, without needing to pay telephone operators for an established speech channel or call connection or the like, by allowing requisite information to be the subject of transmission via free telephone network related control signals, such as ringing signals and A-number identification.

The primary characteristic features of an inventive function control system are set forth in the terminating part of the accompanying claim 1, under sections “a” to “d”.

### BRIEF DESCRIPTION OF THE DRAWINGS

A proposed system for providing, among other things, a function control in respect of a plurality of function practitioners, such as home carers for example, will now be described in more detail with reference to the accompanying drawings, in which

FIG. 1 is a greatly simplified view of a system that utilises a common unit which is connected to a number of subordinate units and which is associated with several home carers;

FIG. 2 illustrates parts of the system in the case of an emergency brought to notice by a home carer;

FIG. 3 illustrates parts of the system in the event of an emergency brought to notice by a customer;

FIG. 4 is a greatly simplified illustration of the system, showing the use of one single common unit;

FIG. 5 illustrates an example of the application of a co-ordinate system used in the inventive system; and

FIG. 6 is a block diagram illustrating a common unit that has various functions associated with the invention.

### DESCRIPTION OF EMBODIMENTS AT PRESENT PREFERRED

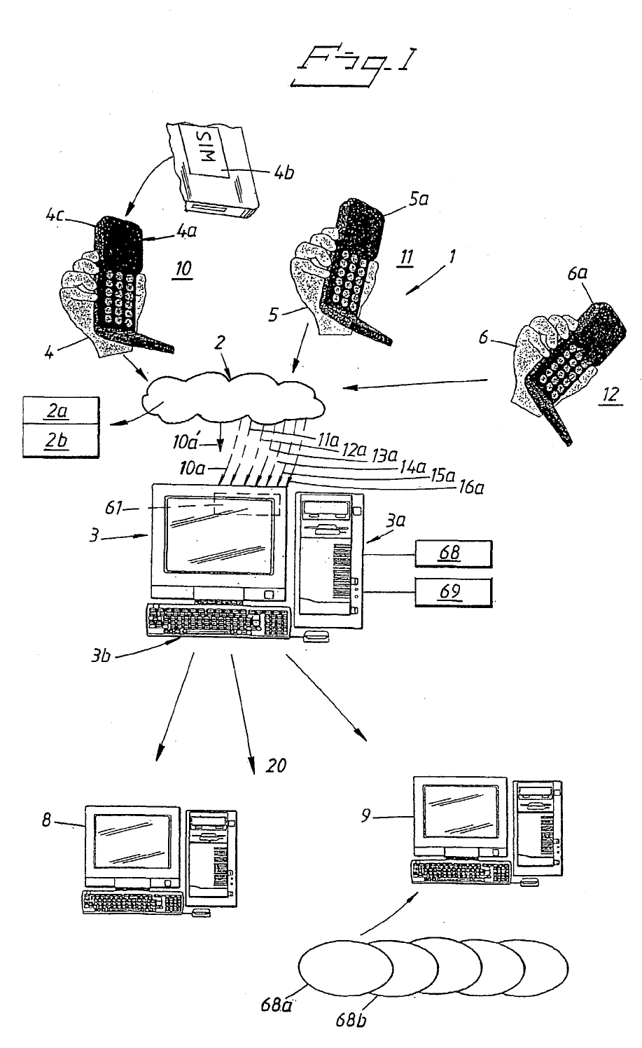

FIG. 1 thus illustrates a system 1 that provides the control of a function.

The system 1 is based on the ability of a function practitioner from among a plurality of available practitioners, for instance in the form of home carers and/or home helpers, to inform a common unit 3 of his/her geographical position and/or a customer related function for reporting and control purposes via a public telephone network or the like 2.

As indicated by reference numeral 4, the geographical position of each home carer is indicated by the common unit 3 when receiving a customer allocated fictive telephone number activated by the home carer, it being assumed that at the time of activating the call said home carer is situated in the proximity of the customer, as indicated at 10.

The unit 3 is adapted to handle requisite communication between said common unit 3 and a mobile telephone apparatus or cellphone reference 4a, 5a 5 and 6a belonging to a respective function practitioner 4, 5 and 6, or vice versa, although primarily communication with said common unit 3.

A first function practitioner, referenced 4, is allocated a first mobile telephone apparatus 4a, a second function practitioner 5 is allocated a second mobile telephone apparatus 5a, and a third function practitioner 6 is allocated a third mobile telephone apparatus 6a.

It will be apparent that for practical application the inventive system will be dimensioned to enable it to be used by more function practitioners than the three functionaries illustrated by way of example in FIG. 1. However, because the functional and practising patterns of all function practitioners and their mobile telephone apparatus are identical, solely the first function practitioner 4 and his/her mobile telephone apparatus 4a will be described in the following description.

Although the duties of home carers and home helpers are somewhat different to one another, albeit identical in many instances, the following description is solely concentrated on the home carer 4 in order to simplify the description.

The present invention is based on the concept of a function practitioner or home carer 4 having access to a mobile telephone apparatus 4a and, in the presence of a customer, indicated at 10 but not shown in any detail, activating, via said telephone apparatus 4a, functions included in the telephone network and the telephone exchanges or switching centres for initiating a call to said common unit 3 via the telephone network 2.

This is effected by the home carer 4 initiating a call 3 via a telephone number 10a allocated to a customer 10 in the unit 3.

In the following description, this telephone number 10a is considered to be a “fictive” telephone number which is separate from the own subscriber number of the customer 10 included in the telephone network or system 2.

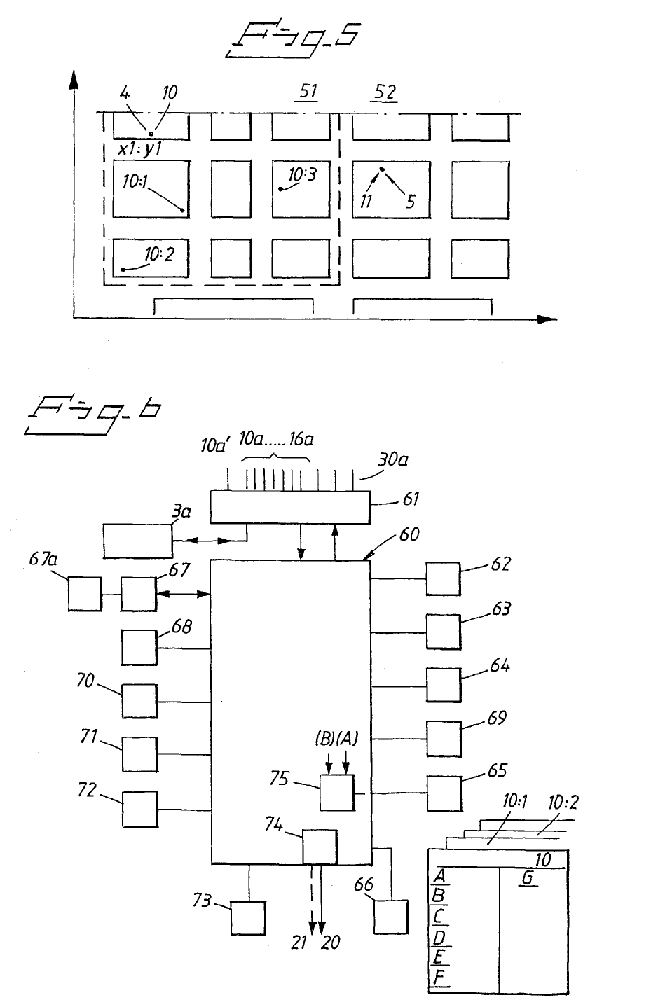

Each home carer 4 shall be assumed to be able to serve several customers, such as the customers referenced 10:1, 10:2 and 10:3 respectively shown in FIG. 5 and having the same or different needs.

Similarly, remaining customers, such as those served by the home carer 4, have their own “fictive” telephone numbers which are different from their own respective subscriber numbers and from other fictive telephone numbers, although with the exception of the special application of the distribution of said fictive telephone numbers as described hereinafter.

There is nothing to prevent a customer who lacks an own subscriber number to the telephone network from being allocated a chosen fictive telephone number to the common unit 3.

The home carers 5 and 6 associated with other customers are similarly provided with their own fictive telephone numbers.

In FIG. 1, the fictive telephone number of the customer 10 is illustrated as an incoming line 10a to the common unit 3.

Similarly, fictive telephone numbers given to customers 11 and 12 have been allocated incoming lines 11a, 12a to the common unit 3.

Although the lines 10a, 11a, 12a . . . have been illustrated in the figures as physical lines for the sake of simplification, these system lines may be virtual.

The common unit 3 will now be described and explained in more detail with reference to FIG. 1 and FIG. 6, so that its relevant system-related functions will become more apparent.

Circuits and blocks which do not directly assist in obtaining a better understanding of the invention have therefore been omitted from the drawings.

The illustrated blocks can be constructed and mutually connected by the person skilled in this art, on the basis of the illustrated functions.

The common unit 3 is designed to receive and register control signals sent from the telephone network 2 and its telephone exchanges. These control signals originate from each call and are initiated by and associated with said function practitioner or home carer, such as the home carer 4.

As shown in FIG. 6, an input circuit 61 and a unit 62 are adapted to determine and register, with the aid of a calculating and control unit 60, call signals sent from the telephone network 2 to the unit 3 in the form of ringing signals, and to create conditions which prevent coupling of the telephone apparatus to a speech channel in response to said ringing signals, such speech connection or the like being unnecessary in respect of the application of the invention.

A unit 63 and its associated memory determines the identity of the A-number of the mobile telephone apparatus 4a sent from the telephone network 2, and a unit 64 and its associated memory determine and store the call number concerned, i.e. B-number identification.

The unit 3 may conveniently be a computer-loaded equipment or a server that includes a known, tested audio response system 3a, so that different information relating to the customers concerned, here illustrated primarily as the customer 10, can be registered in the unit 3 in a memory 65 over an established speech connection 10a′ or the like.

It will be apparent that such person-related information may also be stored by activating keys on a keyboard 3b belonging to the common unit 3.

It is of particular significance that several pieces of information concerning the customer 10 can be stored in the memory 65.

As illustrated schematically in FIG. 6, the name of the customer 10 may conveniently be given in field A in the memory 65, while the customer's address may be given in field B, any temporary address or an instant address may be given in field C, the co-ordinates of the global or geographic position applicable to the address given in field B or the address of higher priority given in field C may be given in field D, the customer's fictive telephone number to the unit 3 may be given in field E, and different customer data, such as more permanent information, may be given in field F.

Different customer-related external events or activities shall be inserted in field G of the memory 65. Information relating to such events may be entered by the home carer 4 via his/her mobile telephone apparatus 4a, by activating different telephone numbers, together with the time of the commencement and/or termination of a chosen event.

The time at which a call is activated by the home carer 4 or some other actor can be stored via a circuit 66 and its associated memory with the aid of a time circuit 69 coupled to the unit 60.

In the illustrated case, the memory 65 is allocated to the customer 10. Corresponding memories are also allocated to other customers linked to the system, such as the customers 10:1; 10:2, these further customers not being described here.

Moreover, each relevant notation concerning each call to the common unit 3 that concerns the customer 10 is entered in the field G of the memory 65. This notation will at least include the time at which the call was activated and an A-number identification associated with the calling home carer 4, i.e. the system allocated subscriber number of the mobile telephone apparatus 4a of the calling home carer 4.

It shall be possible to store each call or other significant information transmission concerning the customer 10 in the field G of the memory 65, so that a complete follow-up of each event and each time point relating to the customer 10 is achieved.

For simplification, the telephone network and its associated telephone exchanges (not shown in detail) shall be considered to consist of two function parts, a first function part 2a and a second function part 2b.

The first function part 2a relates to the internal signal exchange required via control signals before the establishment of a speech channel or speech connection takes place via the function part 2b.

The internal signal exchange in the function part 2a shall not only deliver to the common unit 3 information relating to the function practitioner 4 concerned, by an A-number identification stored in the unit 63, but also information relating to a chosen customer 10, by the function practitioner 4 activating his/her fictive subscriber number, which is received in the input circuit 61 and stored in the unit 63.

A call activated via the mobile telephone apparatus 4a thus comprises a fictive customer-related subscriber number allocated to the common unit 3, preferably also a code or number allocated to the customer 10, this code being fed to the unit 3 and stored in the memory intended therefor.

The structure and design of the unit 3 may be varied within wide limits for receiving, storing and processing information received from the incoming signals from the telephone network.

The unit 3 shall be assumed to be intelligent, and FIG. 6 is a block diagram illustrating such a unit. In order to simplify the description, the circuits and requisite computer units and memories have not been included.

According to the exemplifying embodiment shown in FIG. 1, the common unit 3 is coupled to one or more subordinate units, of which two referenced, 8, 9, are shown.

It will be obvious that more than two subordinate units may be coupled to the common unit 3.

These subordinate units 8, 9 of the FIG. 1 embodiment have been allocated a function which is more of a registering function, wherewith information collected and processed in the unit 3 can be transmitted, for instance via a data network such as the Internet.

There is nothing to prevent such information being transferred over the public telephone network, via an established speech channel and a speech connection.

However, the embodiment according to FIG. 1 illustrates that the unit 9 shall be seen as a unit intended for collecting from the unit 3 solely information that relates to a number of group-co-ordinated function practitioners, such as home carers, referenced 4, 5 and 6 respectively in FIG. 1.

Group-co-ordinated home carers 4, 5 and 6 may be allotted to one and the same community, a selected part of a community, or to a similar area which is well defined geographically and which may, of course, overlap adjacent areas so that it can readily be adapted to practical considerations.

A simplified example of one such part of a community within the core of a city or town is shown in more detail in plan view in FIG. 5.

An area allocated to a first home carer 4 is referenced 51, and an area allocated to a second home carer 5 is referenced 52.

The home carer 4 is assumed to be in the presence of the customer or the care receiver 10 and that he/she has also been allocated other customers within his/her district, of which some have been referenced 10:1; 10:2 and 10:3.

The co-ordinates of the permanent addresses of respective customers are stored in field B of the memory 65, or the co-ordinates of a temporary address are stored in the field C when appropriate.

The co-ordinates x1:y1 shown in FIG. 5 shall be assumed to concern the customer 10. Although not shown, other co-ordinates will be applicable to the addresses of other customers 10:1; 10:2 and so on.

The system or the unit 3 may correctly assume from the calls initiated by the home carer 4 to the unit 3 from the customer that the home carer 4 has the same co-ordinates as the customer 10, unless otherwise disclosed.

When the home carer 4 initiates a call to the unit 3 informing that he/she is leaving the customer 10, the instant co-ordinates of the home carer will consist of those that may be considered relevant for the distance between the instant customer 10 and the next following customer 10:1 in an unequivocal handling pattern.

Instant co-ordinates can also be evaluated in respect of the home carer, by making a calculation related to the time taken to move between said two customers and a clear insight with respect to the extent of carer travel in the coordinate system.

If it is now assumed that each home carer 4 has been allocated a number of different customers 10:1; 10:2 and 10:3 respectively situated at mutually different geographical places that consequently have mutually different co-ordinates in a geographically-related co-ordinate system (x-; y-system in FIG. 5) these coordinates and associated fictive telephone numbers may also be coordinated in a circuit or a memory 66.

It can also be assumed that each home carer 4 will move from customer 10 to another customer 10:1; 10:2 and 10:3 sequentially in a chosen order during a working day, or in some other order dictated by prevailing circumstances of which the common unit 3 can be informed in different ways for registration therein.

All customers 10; 10:1, 10:2, 10:3 or care customers allocated to the home carer 4 are also coordinated in a SIM card 4b belonging to the mobile unit 4a.

By way of example, there will now be illustrated the signal exchange that may apply between a home carer 4 and the common unit 3 with respect to a single customer 10.

At the beginning of a working day, the home carer 4 is allocated a SIM card 4b in which customers 10; 10:1; 10:2 and 10:3 are co-ordinated with respect to a district or an area 51.

The home carer 4 places the SIM card in his/her mobile telephone 4a, wherewith the working period can commence.

When the home carer 4 commences his/her working day, a call to the unit 3 is initiated through the medium of a separate subscriber number 30a so that a circuit 67 and associated memory 67a will identify the current A-number and send an acceptance signal. The telephone apparatus 4a is therewith authorised for access to the system 1, particularly via an input circuit 61 to the unit 3.

The telephone apparatus 4a is denied access to the system in the absence of an acceptance signal from the unit 3.

The home carer 4 initiates a further call to the unit 3, via another separate subscriber number 13a, so as to obtain access to or entry into a time recording system 68. The time at which the system was entered is registered by means of a time circuit 69 in the time recording system 68 or in some other memory store.

Although this information is received admittedly by the common unit 3, it can also be sent immediately to a subordinate unit 9 for storage in a memory 68a.

The function practitioner 4 shall in the presence of the customer 10 (at the door of the customer's apartment or building) activate on his/her mobile telephone 4a a further call, via the telephone network 2, to the fictive subscriber number 10a belonging to said customer 10 and associated with said common unit 3, said call being initiated by selecting the name of said customer on the display 4c of the mobile telephone 4a.

The common unit 3 is adapted to transfer information to a subordinate unit 9 concerning the function practitioner 4 and customer 10, this information being registered in a memory 68b together with the current time, via the time circuit 69.

The function practitioner 4 sends to the common unit 3 and/or to a chosen subordinate unit 9, via one or more renewed calls (inside the apartment), information concerning each selected function and/or service, said calls conveniently being initiated from the telephone apparatus 4a with the aid of a card number.

The time at which access to the customer 10 took place is thus noted as a first item in the memory 65 and in the field G.

When in the domain of the customer 10, the home carer 4 shall call the unit 3 at the beginning of each working task or service, using a telephone number that corresponds to the task or service concerned.

This telephone number may be the same for all home carers 4, 5 and 6, and the unit 3 is able to credit the right home carer 4 for services carried out in respect of a chosen customer 10, by identification of the A-number.

When the duty or service has been completed, the home carer 4 may again call the unit 3 on a different telephone number that corresponds to termination of said duty or service.

This telephone number may be the same for all home carers 4, 5 and 6, and the unit 3 is able to credit the right home carer 4 by identification of the A-number.

It may be of particular importance to confirm the ingestion and the time of ingestion of medicine or to confirm other important duties via a telephone call to the unit 3 for registration in the memory 65 and then in the field G.

These pieces of information together with other information will thus be coordinated in the memory 65 for the customer 10 and in the field G.

The function practitioner 4 activates a further call to transmit a status number 15a indicating termination of the function upon completion of said function and/or service in respect of the customer 10.

When all duties applicable to the customer 10 have been completed, a call is activated to units 3 via a telephone number 16a corresponding to completion of said duties or services.

This telephone number may be the same for all home carers 4, 5 and 6, and the unit 3 is able to credit the right home carer 4 by identification of an A-number.

The co-ordinates (x1:y1) of the home carer 4 are now stored in a memory 70 at the commencement of work for the customer 10, wherein the unit 3 is updated and is accurately informed of the whereabouts of the home carer 4 in a coordinate system.

When the home carer 4 leaves the customer 10 and informs the unit 3 in this regard, by activating a telephone number, and moves to the next customer 10:1 on his/her agenda, this is noted in the memory 70, which awaits, via a time circuit (not shown), information relating to the co-ordinates allotted to this next customer. An alarm signal is emitted if these co-ordinates do not arrive within a given time period.

The earlier described calls to the unit 3 are repeated at the next customer 10:1, partly to indicate the arrival of the carer at the customer 2:1 and partly to indicate termination of the visit and departure from said customer subsequent to the performance of respective duties. The home carer 4 may initiate different calls between these indicating calls, to confirm the commencement of and/or the termination of one or more performed services.

At the end of a working day, the function practitioner 4 activates a call to he common unit 3 based on a telephone number 14a adapted for exit from the time recording system 68.

The unit 3 utilises the input circuit 61 for all of the aforesaid calls between home carer 4 and the unit 3, and the unit or the device 62 that detects ringing signals generated and transmitted in the telephone network and the unit or the device 63 that receives and registers the A-number identification but does not respond to he call for a speech channel or speech connection.

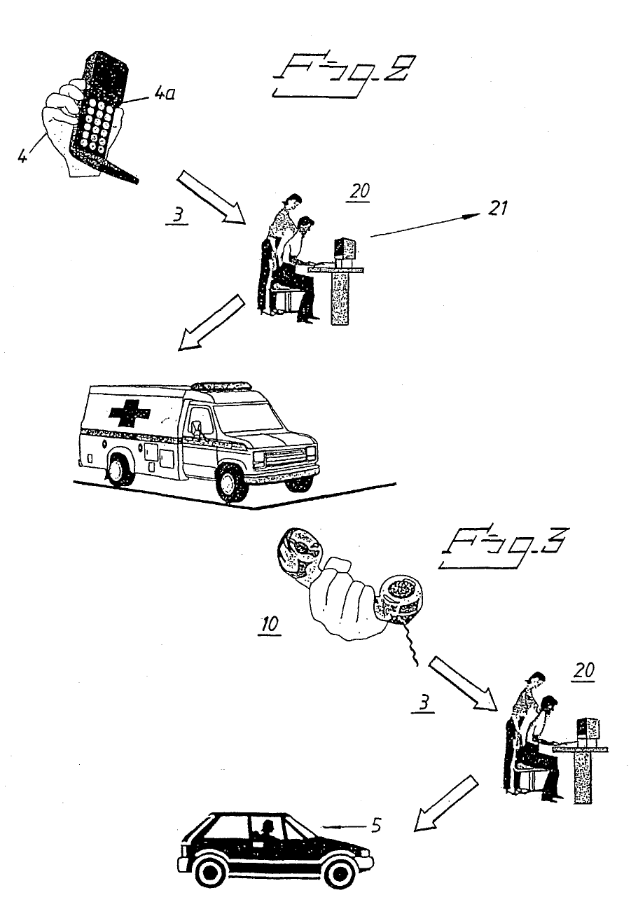

It is particularly proposed in accordance with the invention, as described in FIG. 2, that in the case of an emergency, a function practitioner 4 is able to activate a call number to the unit 3 through the medium of a card number stored in the telephone apparatus 4a, said unit 3 automatically forwarding the call to a manned work management centre 20.

The instant geographical place of the function practitioner 4 and its geographical position is determined on the basis of information stored in the memory 70 or in the field G of the memory 65 and can be transferred to the work management centre 20 either in connection with the call or in order to update the centre with respect to the current co-ordinates.

In the absence of a reply to a call to the work management centre 20 within a predetermined time interval, via a circuit 74, a call is activated to equipment 71 that performs a rescue service.

When a customer 10 considers that he/she is in urgent need of assistance, according to FIG. 3, a call is activated via the unit 3 to the manned work management centre 20, in which the co-ordinates of the geographical positions of respective addresses of each customer are stored from the memory 65 and a calculation can be made to evaluate the nearest and/or the best available function practitioner on the basis of the co-ordinates that currently apply, the co-ordinates of each function practitioner 4, 5, 6 being stored in the memory 70. The appropriate home carer 5 can thus be called.

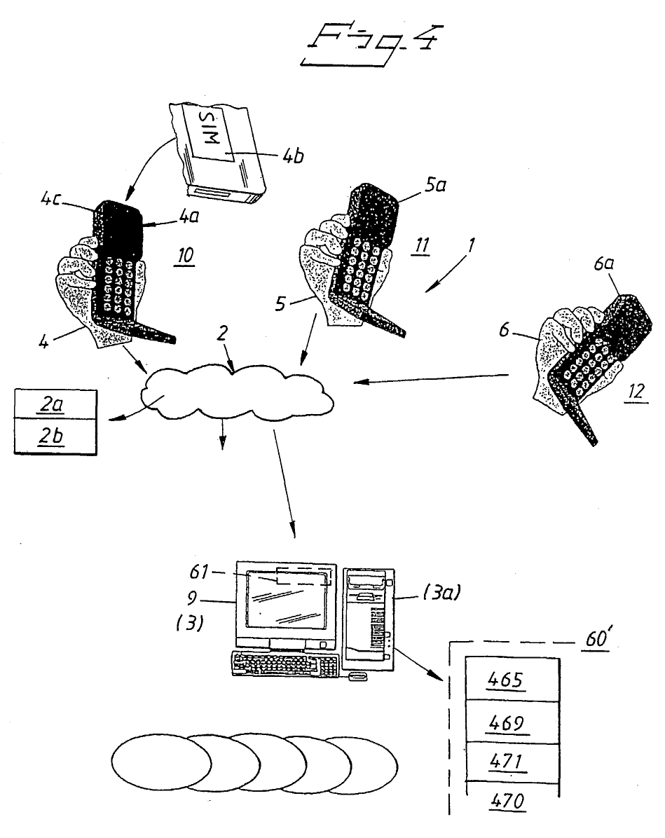

FIG. 4 illustrates an embodiment in which the common equipment or unit 3 is excluded and communication takes place directly between respective home carers 4, 5 and 6 and a “subordinate” unit 9.

The unit 9 of the FIG. 4 embodiment will therefore preferably include all of the functions earlier described with reference to the unit 3 in FIG. 1 and in the block diagram of FIG. 6.

Thus, in the case of the FIG. 4 embodiment each care receiver 10 shall be registered in a customer register 465 (corresponding to the memory 65 in FIG. 6) and be represented by a fictive telephone number included in the register in unit 9.

As in the earlier case, each of the home carers 4, 5, 6 is equipped with a personal mobile telephone apparatus (GSM, or the like) whose SIM card is updated with a fictive telephone number belonging to respective care receivers to be so visited within a district.

In updating the SIM card 4b, there is used a computer-based card support where customer addresses are registered together with customer names and the fictive telephone numbers of said customers, among other things.

The updated SIM card 4b is placed in the mobile telephone apparatus 4a of respective home carers.

The arrival of a home carer at a customer's premises is registered by taking the fictive telephone number of the customer from the register of the mobile telephone, and thereafter attempting to call the unit 9. The call is registered and time-stamped in a memory 469 in the unit 9 without needing to be answered.

Each of certain common telephone numbers in a memory 471 may represent a specific type of event or activity. For example, such a telephone number belonging to said unit may represent the commencement/termination of the work relating to a customer or to a care receiver, while another of said telephone numbers may represent the duties performed, such as cleaning, shopping, washing-up, administration of medicaments, etc., remote control of lock opening, determining patient status in the form of body temperature, general condition, the need of auxiliary help, and so on.

Each service has its own telephone number and the carer is credited correctly in response to A-number identification.

Respective measures are registered or ordered, by coupling the telephone number concerned to the unit 3. The call is registered and time-stamped by the unit 3 without answering the ring signal generated by coupling the call to the telephone network 2.

If further verification of the visit is required, the customer's telephone number can be registered in the system and the call is made to a special number in the system. This call need not be answered either, since the system registers the A-number of the customer telephone and the time at which the call was made.

A care receiver or customer that possesses a so-called security telephone which delivers an emergency call to a care patrol or emergency centre when activated can be served effectively in the system.

Because the customer telephone number is registered as an A-number and because the emergency call is sent to a special telephone number in the unit 3 or the unit 9, the call can be delivered to the mobile telephone apparatus (or to a land-based telephone) or to an emergency centre used by the care patrol or home carer concerned.

An emergency call is registered and answered primarily by the audio response function 3a of the system.

A determined emergency measure is carried out automatically by the system and the system notifies the home carer concerned by ringing-up his/her telephone apparatus.

In order to achieve a safe control, it is then necessary for the home carer to call back the system in order to “collect” patient data and the actual emergency message.

The system therewith registers the identification of the home carer and takes over all further responsibility of dealing with the emergency message.

If the home carer fails to acknowledge the call, the system automatically continues with the established emergency plan and a new home carer is notified.

Because the system retains all information concerning the emergency call in question, there is no information gap in the handling process.

The necessary degree of safety is achieved as a result of this acknowledgement requirement, at the same time as important customer information can be delivered to the home carer prior to the carer being connected to the “parked” emergency message.

In addition, each emergency message is fetched through the medium of a specific telephone number, which may be included in a special number series, to which a call can be connected at a discount in accord with an agreement reached with respective telephone operators.

As a result of a map-based GIS function in the circuit and the memory 470, an incoming emergency call can be forwarded automatically to an appropriate patrol or home carer situated in the vicinity of the person seeking help, therewith making the procedure more efficient and shortening the time taken for assistance to arrive.

If the need for quicker assistance arises, the home carer can activate an alarm signal immediately, with the aid of a given card number.

Each emergency message is automatically supplemented with customer or patient data, geographic co-ordinates, travel instructions and the telephone number of the home carer present with the customer, through the medium of said system. As a result of the system function, the home carer is able to concentrate fully on the emergency work required by the customer.

The system solution also provides a simple assault alarm for the home carer. Because the geographical position of the home carer is known, or can be readily calculated in the system due to the information received and stored, an assault alarm can be triggered by an alarm button or with the aid of a special card number on the mobile telephone apparatus.

The system may be provided with open interfaces for a call connection and the transfer of information to existing wage/salary statistics and accounting routines.

The aforedescribed system 1 with the common unit 3 enables individual billing to be effected readily from the memory 65 via a billing system 72.

Historical information can also be stored in a memory 73 in the unit 3 and therewith enable it to be ascertained that the duties carried out lie within predetermined time intervals and/or that each medicine was administered at the proper time.

The control circuits required to this end have not been shown in the drawings, although they can be easily arranged with the aid of known means and circuits.

The temporary address can be inserted via a fictive subscriber number and/or via the audio response system 3a.

When the customer 10 wishes to contact his/her home carer 4 in his/her absence, the customer calls a unit-associated telephone number and the unit 3 can, in response, call an allocated home carer 4 instructing him/her to contact the customer 10 immediately. This sequence can be afforded via the audio response system 3a and an established speech channel or speech connection.

When the home carer 4 calls the common unit 3 via a special emergency number and the unit 3 is unable to find an available home carer in the immediate neighbourhood, the call is forwarded to the work management centre 20.

In the case of an emergency call, it also lies within the possibilities of the system to couple-in the audio response system 3a so as to enable the interchange of messages to take place, together with time data for subsequent checking of the event.

One and the same fictive telephone number that allows access to the common unit 3 may be allocated to the customer (10, 11 respectively) of each respective home carer 4 and 5, therewith reducing the number of fictive telephone numbers that would otherwise be required for significant access of the customers to the common unit 3.

With the aid of a unit or a circuit 75, each such customer 10 or 11 having the same fictive telephone number can be clearly determined by, in addition, determining the subscriber number allocated to the mobile telephone apparatus of the home carer.

The circuit 75 can thus determine the identity of one, and only one, customer 10 with the aid of a B-number identification process (B) and an A-number identification process (A) and store the information received in the memory 65 and thus in the field G.

It will be understood in particular that the designation “customer” does not solely include a care receiver or some other physical person, as exemplified above, but will also include a chosen position in which security personnel acknowledge their presence. The unit 3 can therewith follow the security guard (or watcher) time-wise during his/her round and register time-wise the current coordinates of the guard.

Those who are skilled in this technique will be aware of the modifications and changes that are required to the illustrated system, particularly the system illustrated in FIGS. 1, 4 and 6, in order to convert the home care related system 1 to a system for security personnel. It will also be obvious that several of the aforedescribed functions can be omitted or supplemented to some extent in order to adapt the system to a security system as necessary or desired.

For example, the customers 10; 10:1; 10:2; and so on in a security system or guard system may consist of chosen geographical positions at which a guard shall acknowledge his/her presence and/or carry out a duty either by physically taking a predetermined measure or by initiating a call from his/her mobile telephone apparatus to a centre unit or a common unit 3 by using a call number allocated to said position and adapted to said unit, this call number conveniently consisting of a card number.

It will be understood that the invention is not restricted to the aforedescribed exemplifying embodiments and that modifications can be made within the scope of the inventive concept as defined in the following Claims.

1. A function control system (1) in which one of a number of available function practitioners (4) is able to report to a common unit (3) via a telephone network (2) a position and/or customer-related function, wherein said unit (3) is adapted to handle communication at least from mobile telephone apparatus activated within the telephone network and belonging to respective function practitioners, wherein
(a) the function practitioner (4) shall activate a customer-connected call to said common unit (3) via his/her mobile telephone apparatus through the telephone network, said unit (3) therewith receiving a customer-allocated fictive telephone number activated by the function practitioner (4);
(b) wherein said common unit (3) is adapted to receive and register control signals which are sent from the telephone network and which originate from the call initiated by said function practitioner;
(c) wherein the common unit (3) is adapted in a known way to register chosen call-related criteria, such as at least the time at which the call was initiated, the function practitioner and the customer concerned; and
(d) wherein the common unit (3) functions to register at least the function practitioner and the customer concerned via a signal exchange related to said control signals and associated with the call delivered by and generated in the telephone network.

2. A system according to claim 1, characterised in that the common unit is coupled to one or more subordinate units.

3. A system according to claim 1 or 2, characterised in that the customers or corresponding entities associated with a function practitioner are coordinated in a SIM card belonging to said mobile telephone apparatus.

4. A system according to claim 1, characterised in that the function practitioner (4) activates a call to the common unit (3) with the aid of a telephone number adapted to permit access to a time recording system.

5. A system according to claim 4, characterised in that information received by the common unit is transferred to a subordinate unit for storage therein.

6. A system according to claim 1, characterised in that in order to carry out step “(a)”, the function practitioner selects the name of a customer on a display belonging to the telephone apparatus and initiates a call.

7. A system according to claim 1 or 6, characterised in that the common unit (3) is adapted for the transmission of information to a subordinate unit with respect to the function practitioner and the customer concerned; and that this information is registered together with the time at which the information was registered.

8. A system according to claim 1, characterised in that the function practitioner sends to the common unit and/or to a chosen subordinate unit through the medium of a call, information concerning the commencement of each selected function and/or service.

9. A system according to claim 8, characterised in that said call is activated by means of a card number.

10. A system according to claim 8 or 9, characterised in that upon termination of a function and/or service, the function practitioner makes a further call to transmit information with the aid of a status number relating to said termination of the function or service.

11. A system according to claim 1, characterised in that the function practitioner activates a call to the common unit with the aid of a telephone number adapted for exiting from a time recording system.

12. A system according to claim 1, characterised in that in the event of an emergency the function practitioner activates a call number, stored as a card number, to said unit, said unit being in contact with a manned work management centre.

13. A system according to claim 1 or 12, characterised in that the geographical location of the function practitioner and his/her geographical position is determined on the basis of information obtained in step “(a)” and can be transferred to a work management centre.

14. A system according to claim 1 or 12, characterised in that in the event of a call to the unit and/or to the work management centre being unanswered within a predetermined time interval, a call to a rescue service is activated.

15. A system according to claim 1 or 12, characterised in that when a customer considers himself/herself to be in urgent need of help, a call associated with the telephone network is made to said unit which is in contact with the manned work management centre in which the co-ordinates of the geographical position of each customer is stored, wherein the nearest and/or the best available function practitioner can be summoned on the basis of the co-ordinates relating to each function practitioner.

16. A system according to claim 1, characterised in that each customer in the form of a care receiver is registered in a customer register with the aid of a fictive unit-allocated telephone number.

17. A system according to claim 3, characterised in that the SIM card is updated with the aid of a computer-based card support, where the address of the care receiver is registered together with his/her name and a fictive telephone number allocated to the customer.

18. A system according to claim 1, 3 or 17, characterised in that an arrival at a chosen customer or corresponding entity is registered by calling the fictive telephone number of the customer via the internal register of the mobile telephone apparatus.

19. A system according to claim 1, characterised in that a telephone number allocated to several function practitioners is adapted to represent a specific type of function or event.

20. A system according to claim 1, characterised in that one and the same fictive telephone number is allocated a client for several home carers or for each home carer; and in that each customer can be determined clearly by determining a subscriber number allocated to the mobile telephone apparatus of the home carer.
